(19) United States
(12) Patent Application Publication
(10) Pub. No.: US 2019/0006679 A1
(43) Pub. Date: Jan. 3, 2019

(54) ANODE AND LITHIUM BATTERY INCLUDING THE SAME

(71) Applicant: SAMSUNG SDI CO., LTD., Yongin-si (KR)

(72) Inventors: Changui JEONG, Yongin-si (KR); Jiyeon KWAK, Yongin-si (KR); Youngugk KIM, Yongin-si (KR); Uisong DO, Yongin-si (KR); Sangeun PARK, Yongin-si (KR); Yuntaek OH, Yongin-si (KR); Yongchan YOU, Yongin-si (KR); Inoh CHA, Yongin-si (KR); Heeseon CHOI, Yongin-si (KR)

(21) Appl. No.: 16/023,238

(22) Filed: Jun. 29, 2018

(30) Foreign Application Priority Data
Jul. 3, 2017 (KR) 10-2017-0084401

(51) Int. Cl. H01M 4/62; H01M 4/133; H01M 4/134; H01M 4/36; H01M 4/38; H01M 4/587; H01M 10/0525; H01M 10/0587

(52) U.S. Cl. CPC H01M 4/628; H01M 4/133; H01M 4/134; H01M 4/364; H01M 2004/027; H01M 4/587; H01M 10/0525; H01M 10/0587; H01M 4/622; H01M 4/386

(57) ABSTRACT

An anode includes a composite anode active material including a core and a coating layer on the core, the core including a metal alloyable with lithium. The coating layer includes a first polymer having a first functional group and a binder including a second polymer having a second functional group. The first polymer and the second polymer are cross-linked with each other via ester bonding between the first functional group and the second functional group.

### CROSS-REFERENCE TO RELATED APPLICATION

Korean Patent Application No. 10-2017-0084401, filed on Jul. 3, 2017, in the Korean Intellectual Property Office, and entitled: “Anode and Lithium Battery Including the Same,” is incorporated by reference herein in its entirety.

### BACKGROUND

### 1. Field

One or more embodiments relate to anodes and lithium batteries including the same.

### 2. Description of the Related Art

Lithium batteries have high voltage and high energy density, and thus are used in various applications. For example, lithium batteries with excellent discharge capacity and lifespan characteristics are desirable for use in, for example, electric vehicles (e.g., hybrid electric vehicles (HEVs) and plug-in HEVs (PHEVs)).

### SUMMARY

Embodiments are directed to an anode including a composite anode active material including a core and a coating layer on the core, the core including a metal alloyable with lithium. The coating layer includes a first polymer having a first functional group and a binder including a second polymer having a second functional group. The first polymer and the second polymer are cross-linked with each other via ester bonding between the first functional group and the second functional group.

The first functional group and the second functional group may each independently include at least one selected from a carboxyl group, a hydroxyl group, an amide group, and an aldehyde group.

The first functional group may be a carboxyl group (—COOH), and the second functional group may be a hydroxyl group ((—OH).

The first polymer may include at least one selected from polyacrylic acid and polyamic acid.

The first polymer may be a polyacrylic acid represented by Formula 1 below:

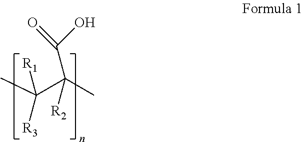

wherein, in Formula 1, R₁, R₂, and R₃ are each independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group; and n is a degree of polymerization of about 10 to about 10,000.

The first polymer may be a polyamic acid represented by Formula 2 below:

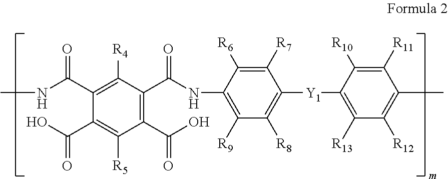

wherein, in Formula 2, R₄, R₅, R₆, R₇, R₈, R₉, R₁₀, R₁₁, R₁₂, and R₁₃ are each independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group; Y₁ is a single bond, —O—, —S—, —C(═O)—, —S(═O)₂—, —Si(Rₐ)(R_{b})—, a C₁-C₁₀ alkylene group substituted with a halogen, an unsubstituted C₁-C₁₀ alkylene group, or —C(═O)—NH—, wherein Rₐ and R_{b} are each independently a C₁-C₁₀ alkyl group; and m is a degree of polymerization of about 2 to about 10,000.

An amount of the first polymer may range from about 0.01 wt % to about 5 wt % based on a total weight of the composite anode active material.

The first polymer may have a weight average molecular weight of about 1,000 Daltons to about 250,000 Daltons.

A specific surface area of the composite anode active material may be 80% or less of the specific surface area of the core.

The anode including the composite anode active material may have a thickness expansion rate represented by Equation 3 below. The thickness expansion rate may be 95% or less than a thickness expansion rate of an anode including only the core.

Thickness expansion rate (%)=[(anode thickness after charging-anode thickness before assembling)/anode thickness before assembling]×100 Equation 3

The second polymer may include at least one selected from cellulose hydroxyethyl ether, dextran, carboxymethylcellulose (CMC), alginate, cellulose nanofiber, xanthan gum, and guar gum.

The core may include at least one metal selected from silicon (Si), tin (Sn), aluminium (Al), germanium (Ge), lead (Pb), zinc (Zn), silver (Ag), and gold (Au); an alloy, an oxide, a nitride, an oxynitride, or a carbide of the at least one metal; or a composite of the at least one metal and a carbonaceous material.

The core may include at least one selected from silicon, a silicon alloy, a silicon oxide, a silicon nitride, a silicon oxynitride, a silicon carbide, and a silicon-carbon composite.

The core may include composite particles of silicon and carbon and a carbonaceous coating layer on a surface of the composite particles.

Embodiments are also directed to a lithium battery that includes the anode.

### BRIEF DESCRIPTION OF THE DRAWINGS

Features will become apparent to those of skill in the art by describing in detail exemplary embodiments with reference to the attached drawings in which:

FIG. 1 illustrates a graph showing lifespan characteristics of lithium batteries manufactured according to Examples 8 to 11 and Comparative Example 5;

FIG. 2 illustrates a graph showing lifespan characteristics of lithium batteries manufactured according to Examples 8 and 12 to 14 and Comparative Example 5;

FIG. 3 illustrates a graph showing lifespan characteristics of lithium batteries manufactured according to Example 8 and Comparative Examples 5 to 8;

FIG. 4 illustrates a graph showing lifespan characteristics of lithium batteries according to Comparative Examples 9 to 13; and

FIG. 5 illustrates a schematic view of a lithium battery according to an example embodiment.

### DETAILED DESCRIPTION

Hereinafter, anodes according to example embodiments and lithium batteries including the anodes will be described in more detail.

An anode according to an embodiment may includes a composite anode active material including a core including a metal alloyable with lithium and a coating layer on the core, in which the coating layer includes a first polymer having a first functional group; and a binder including a second polymer having a second functional group. The first polymer and the second polymer may be cross-linked with each other via ester bonding formed by a reaction between the first functional group and the second functional group.

The coating layer of the composite anode active material including the first polymer may partially or completely cover the core, which includes the metal alloyable with lithium. Thus side effects that could occur due to a volumetric change of the core during charging/discharging of a lithium battery may be suppressed, and lifespan characteristics of the lithium battery may be enhanced. In addition, in the composite anode active material, when the coating layer including the first polymer covers the core, a specific surface area of the core may be decreased, and thus, a side reaction between the core and an electrolytic solution may be suppressed.

In addition, the composite anode active material and the binder may be strongly adhered to each other through covalent bonding via cross-linking between the coating layer of the composite anode active material and the binder. Thus, volumetric changes of the composite anode active material and the anode that could occur during charging/discharging of a lithium battery may be suppressed, and deterioration of the composite anode active material and the anode that could occur due to rapid volumetric changes may be suppressed. Accordingly, lifespan characteristics of a lithium battery including the anode may be further enhanced.

In the anode, each of the first functional group and the second functional group may independently be at least one selected from a carboxyl group, a hydroxyl group, an amide group, and an aldehyde group. For example, the first functional group may be a carboxyl group (—COOH), and the second functional group may be a hydroxyl group (—OH). Thus, the first polymer may be a polymer having a carboxyl group, and the second polymer may be a polymer having a hydroxyl group.

The first polymer may be a suitable polymer in the art for coating of an anode active material. For example, in the anode, the first polymer may be at least one selected from polyacrylic acid and polyamic acid

For example, the first polymer may be a polyacrylic acid represented by Formula 1 below:

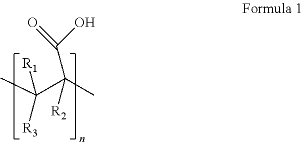

wherein, in Formula 1, each of R₁, R₂, and R₃ is independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group, and n is a degree of polymerization of about 10 to about 10,000.

For example, the first polymer may be a polyamic acid represented by Formula 2 below:

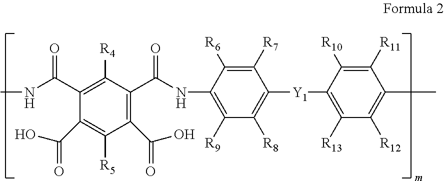

wherein, in Formula 2, each of R₄, R₅, R₆, R₇, R₈, R₉, R₁₀, R₁₁, R₁₂, and R₁₃ is independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group; Y₁ is a single bond, —O—, —S—, —C(═O)—, —S(═O)₂—, —Si(Rₐ)(R_{b})— where each of Rₐ and R_{b} is independently a C₁-C₁₀ alkyl group, a C₁-C₁₀ alkylene group substituted with a halogen, an unsubstituted C₁-C₁₀ alkylene group, or —C(═O)—NH—; and m is a degree of polymerization of about 2 to about 10,000.

The amount of the first polymer in the composite anode active material may be from about 0.01 wt % to about 7 wt % with respect to a total weight of the composite anode active material. For example, the amount of the first polymer in the composite anode active material may be from about 0.05 wt % to about 6 wt % with respect to the total weight of the composite anode active material. For example, the amount of the first polymer in the composite anode active material may be from about 0.1 wt % to about 5 wt % with respect to the total weight of the composite anode active material. For example, the amount of the first polymer in the composite anode active material may be from about 0.1 wt % to about 4 wt % with respect to the total weight of the composite anode active material. When the amount of the first polymer is within the above range, charge/discharge characteristics of a lithium battery may be further enhanced. When the amount of the first polymer is too large, loss in initial charging/discharging efficiency or discharge capacity of a lithium battery may be increased.

In the composite anode active material, the first polymer may have a weight average molecular weight of about 1,000 Daltons to 250,000 Daltons. For example, the weight average molecular weight of the first polymer of the composite anode active material may be from about 1,000 Daltons to 200,000 Daltons. For example, the weight average molecular weight of the first polymer of the composite anode active material may be from about 1,500 Daltons to 150,000 Daltons. For example, the weight average molecular weight of the first polymer of the composite anode active material may be from about 1,500 Daltons to 120,000 Daltons. For example, the weight average molecular weight of the first polymer of the composite anode active material may be from about 1,500 Daltons to 100,000 Daltons. For example, the weight average molecular weight of the first polymer of the composite anode active material may be from about 1,500 Daltons to 80,000 Daltons. For example, the weight average molecular weight of the first polymer of the composite anode active material may be from about 1,500 Daltons to 50,000 Daltons. For example, the weight average molecular weight of the first polymer of the composite anode active material may be from about 1,500 Daltons to 30,000 Daltons. When the weight average molecular weight of the first polymer is within the above range, a lithium battery with enhanced charge/discharge characteristics may be manufactured. When the weight average molecular weight of the first polymer is not too large, dissolution of the first polymer in a solvent, which could result in deteriorated workability, may be avoided.

The composite anode active material, wherein the core is coated with the first polymer, may have a smaller specific surface area than that of the core. For example, the specific surface area of the composite anode active material may account for about 90% or less of the specific area of the core. For example, the specific surface area of the composite anode active material may account for about 85% or less of the specific area of the core. For example, the specific surface area of the composite anode active material may account for about 80% or less of the specific area of the core. For example, the specific surface area of the composite anode active material may account for about 70% or less of the specific area of the core. For example, the specific surface area of the composite anode active material may account for about 60% or less of the specific area of the core. For example, the specific surface area of the composite anode active material may account for about 50% or less of the specific area of the core. For example, the specific surface area of the composite anode active material may account for about 40% or less of the specific area of the core. For example, the specific surface area of the composite anode active material may account for about 30% or less of the specific area of the core. For example, the specific surface area of the composite anode active material may account for about 20% or less of the specific area of the core. When the specific surface area of the composite anode active material is small relative to the specific surface area of the core, a side reaction between the composite anode active material and an electrolytic solution may be decreased, and thus a lithium battery with enhanced lifespan characteristics may be manufactured.

The anode including the composite anode active material, wherein the core is coated with the first polymer, may have a thickness expansion rate that is smaller than that of an anode including an anode active material consisting only of the core. For example, the thickness expansion rate of the anode including the composite anode active material may be about 95% or less of that of the anode including only the core as an anode active material. For example, the thickness expansion rate of the anode including the composite anode active material may be about 90% or less of that of the anode including only the core as an anode active material. For example, the thickness expansion rate of the anode including the composite anode active material may be about 85% or less of that of the anode including only the core as an anode active material. For example, the thickness expansion rate of the anode including the composite anode active material maybe about 80% or less of that of the anode including only the core as an anode active material. For example, the thickness expansion rate of the anode including the composite anode active material may be about 70% or less of that of the anode including only the core as an anode active material. For example, the thickness expansion rate of the anode including the composite anode active material may be about 60% or less of that of the anode including only the core as an anode active material. For example, the thickness expansion rate of the anode including the composite anode active material may be about 50% or less of that of the anode including only the core as an anode active material. For example, the thickness expansion rate of the anode including the composite anode active material may be about 30% or less of that of the anode including only the core as an anode active material. When the thickness expansion rate of the anode including the composite anode active material is lower than that of an anode including only the core as an anode active material, a side reaction between the composite anode active material and an electrolytic solution may be decreased, and thus a lithium battery with enhanced lifespan characteristics may be manufactured.

The thickness expansion rates described above are determined by the following Equation 3.

Thickness expansion rate (%)=[(thickness of anode after charging−thickness of anode before assembling)/thickness of anode before assembling]×100 Equation 3

In the anode, the second polymer may include at least one selected from cellulose hydroxyethyl ether, dextran, carboxymethylcellulose (CMC), alginate, cellulose nanofiber, xanthan gum, and guar gum. The second polymer may be, for example, a suitable hydroxyl group-containing binder capable of forming an ester bond with a carboxyl group.

Cross-linking of the first polymer and the second polymer via ester bonding formed by a reaction between the carboxyl group of the first polymer and the hydroxyl group of the second polymer may occur at a predetermined temperature. For example, cross-linking between the first polymer and the second polymer may not occur when the first polymer and the second polymer are simply mixed at room temperature. To initiate the cross-linking between the first polymer and the second polymer, a temperature of about 80° C. or more may be applied to a mixture of the first polymer and the second polymer. For example, to cross-link the first polymer and the second polymer, a temperature of about 100° C. or more may be applied to the mixture of the first polymer and the second polymer. For example, to cross-link the first polymer and the second polymer, a temperature of about 120° C. or more may be applied to the mixture of the first polymer and the second polymer. For example, to cross-link the first polymer and the second polymer, a temperature of about 140° C. or more may be applied to the mixture of the first polymer and the second polymer. For example, the first polymer and the second polymer may be fully cross-linked with each other by including a process of drying an anode active material composition at a temperature of about 100° C. or more. For example, the first polymer and the second polymer may be fully cross-linked with each other by including a process of drying an anode active material composition at a temperature of about 120° C. or more. For example, the first polymer and the second polymer may be fully cross-linked with each other by including a process of drying an anode active material composition at a temperature of about 150° C. or more. A drying temperature of the anode active material composition may be about 200° C. or less. When the drying temperature within the range, pyrolyzing of the first polymer or the second polymer may be avoided.

The core included in the composite anode active material may include at least one metal alloyable with lithium selected from silicon (Si), tin (Sn), aluminium (Al), germanium (Ge), lead (Pb), zinc (Zn), silver (Ag), and gold (Au), an alloy, an oxide, a nitride, an oxynitride, or a carbide of the at least one metal, or a composite of the at least one metal and a carbonaceous material. The carbonaceous material may be a suitable carbonaceous material in the art. Examples of the carbonaceous material may include flake-type graphite, crystalline graphite, amorphous graphite, artificial graphite, carbonaceous mesophase spheres, cokes, carbon nanotubes, carbon nanofibers, graphene, or graphene oxides.

For example, the core may include at least one selected from silicon, a silicon alloy, a silicon oxide, a silicon nitride, a silicon oxynitride, a silicon carbide, and a silicon-carbon composite. For example, the silicon-carbon composite may be a silicon-carbon nanocomposite. The term “silicon-carbon nanocomposite” refers to a composite in which at least one of silicon and carbon has a nano-scale size of less than 1 μm. For example, the silicon-carbon nanocomposite may be a composite in which silicon nanoparticles and carbon nanoparticles are complexed.

For example, the core may include composite particles of silicon and carbon and a carbonaceous coating layer disposed on a surface of the composite particles. The carbonaceous coating layer may include amorphous carbon. For example, carbon included in the coating layer may be a calcined product of a carbon precursor. The carbon precursor may be a suitable carbonaceous material in the art and may be obtained by calcination. For example, the carbon precursor may be at least one selected from a polymer, coal tar pitch, petroleum pitch, meso-phase pitch, coke, low molecular weight heavy oil, a coal-based pitch, and derivatives thereof. Due to formation of the carbonaceous coating layer on the core, a solid electrolyte interface (SEI) may be formed, and Li⁺ ions may selectively pass through the SEI, thereby preventing contact between silicon and an electrolytic solution or the like. The amount of the coating layer is may range from, for example about greater than 0 wt % to about 10 wt % with respect to a total weight of the core. For example, the amount of the coating layer may range from about 1 wt % to about 8 wt % based on the total weight of the core including the coating layer. For example, the amount of the coating layer may range from about 1 wt % to about 6 wt % based on the total weight of the core including the coating layer. For example, the amount of the coating layer may range from about 1 wt % to about 4 wt % based on the total weight of the core including the coating layer.

The anode may be manufactured by a suitable method. For example, the anode may be manufactured by molding, into a certain shape, an anode active material composition including the composite anode active material including the first polymer, e.g., the first polymer coated on the core, and the binder including the second polymer, or applying the anode active material composition to a current collector such as copper foil or the like.

For example, an anode active material composition may be prepared by mixing the composite anode active material, a conductive material, a binder, and a solvent. The anode active material composition may be directly coated onto a metal current collector to manufacture an anode plate. In another implementation, the anode active material composition may be cast onto a separate support, and then a film separated from the support may be laminated onto a metal current collector to manufacture an anode plate.

A suitable conductive material may be used. Examples of the conductive material include acetylene black, Ketjen black, natural graphite, artificial graphite, carbon black, carbon fibers, and metallic powder and fibers of copper, nickel, aluminum, or silver. In addition, a conductive material such as polyphenylene derivatives or the like may be used alone, or one or more thereof may be used in combination. In some implementations, the crystalline carbonaceous material described above may be added as a conductive material.

A suitable binder may be used. For example, the binder may be, in addition to the first binder described above, a vinylidene fluoride/hexafluoropropylene copolymer, polyvinylidene fluoride (PVDF), polyacrylonitrile, polymethyl methacrylate, polytetrafluoroethylene, a mixture of the aforementioned polymers, a styrene-butadiene rubber-based polymer, or the like.

A suitable solvent may be used. For example, the solvent may be N-methylpyrrolidone, acetone, water, or the like.

The amounts of the composite anode active material, the conductive material, the binder, and the solvent may be the same as those used in a general lithium battery. At least one of the conductive material, the binder, and the solvent may omitted according to a use and constitution of desired lithium batteries.

According to an embodiment, a lithium battery may include the anode including the composite anode active material described above. The lithium battery may be manufactured using the following method.

An anode may be prepared according to the fabrication method of an anode described above.

Next, a cathode active material composition, in which a cathode active material, a conductive material, a binder, and a solvent are mixed, may be prepared. The cathode active material composition may be directly coated onto a metal current collector and dried to manufacture a cathode plate. In another implementation, the cathode active material composition may be cast onto a separate support, and then a film separated from the support may be laminated onto a metal current collector to thereby complete the manufacture of a cathode plate.

A suitable cathode active material that may be used. For example, the cathode active material may include at least one selected from lithium cobalt oxide, lithium nickel cobalt manganese oxide, lithium nickel cobalt aluminum oxide, lithium iron phosphate, and lithium manganese oxide.

For example, the cathode active material may be a compound represented by one of the following formulae: LiₐA_{1-b}B′_{b}D′₂ where 0.90≤a≤1.8 and 0≤b≤0.5; LiₐE_{1-b}B′_{b}O_{2-c}D′ where 0.90≤a≤1.8, 0≤b≤0.5, and 0≤c≤0.05; LiE_{2-b}B′_{b}O_{4-c}D′_{c} where 0≤b≤0.5 and 0≤c≤0.05; LiₐNi_{1-b-c}Co_{b}B′_{c}D′_{α} where 0.90≤a≤1.8, 0≤b≤0.5, 0≤c≤0.05, and 0<α≤2; LiₐNi_{1-b-c}Co_{b}B′_{c}O_{2-α}F′_{α} where 0.90≤a≤1.8, 0≤b≤0.5, 0≤c≤0.05, and 0<α<2; LiₐNi_{1-b-c}Co_{b}B′_{c}O_{2-α}F′₂ where 0.90≤a≤1.8, 0≤b≤0.5, 0≤c≤0.05, and 0<α<2; LiₐNi_{1-b-c}Mn_{b}B′_{c}D′_{α} where 0.90≤a≤1.8, 0≤b≤0.5, 0≤c≤0.05, and 0<α≤2; LiₐNi_{1-b-c}Mn_{b}B′_{c}O_{2-α}F′_{α} where 0.90≤a≤1.8, 0≤b≤0.5, 0≤c≤0.05, and 0<α<2; LiₐNi_{1-b-c}Mn_{b}B′_{c}O_{2-α}F′₂ where 0.90≤a≤1.8, 0≤b≤0.5, 0≤c≤0.05, and 0<α<2; LiₐNi_{b}E_{c}G_{d}O₂ where 0.90≤a≤1.8, 0≤b≤0.9, 0≤c≤0.5, and 0.001≤d≤0.1; LiₐNi_{b}Co_{c}Mn_{d}GeO₂ where 0.90≤a≤1.8, 0≤b≤0.9, 0≤c≤0.5, 0≤d≤0.5, and 0.001≤e≤0.1; LiₐNiG_{b}O₂ where 0.90≤a≤1.8 and 0.001≤b≤0.1; LiₐCoG_{b}O₂ where 0.90≤a≤1.8 and 0.001≤b≤0.1; LiₐMnG_{b}O₂ where 0.90≤a≤1.8 and 0.001≤b≤0.1; LiₐMn₂G_{b}O₄ where 0.90≤a≤1.8 and 0.001≤b≤0.1; QO₂; QS₂; LiQS₂; V₂O₅; LiV₂O₅; LiI′O₂; LiNiVO₄; Li_{(3-f)}J₂(PO₄)₃ where 0≤f≤2; Li_{(3-f)}Fe₂(PO₄)₃ where 0≤f≤2; and LiFePO₄.

In the above formulae, A may be selected from nickel (Ni), cobalt (Co), manganese (Mn), and combinations thereof; B′ may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D′ may be selected from oxygen (O), fluorine (F), sulfur (S), phosphorus (P), and combinations thereof; E may be selected from cobalt (Co), manganese (Mn), and combinations thereof; F′ may be selected from fluorine (F), sulfur (S), phosphorus (P), and combinations thereof; G may be selected from aluminum (Al), chromium (Cr), manganese (Mn), iron (Fe), magnesium (Mg), lanthanum (La), cerium (Ce), strontium (Sr), vanadium (V), and combinations thereof; Q is selected from titanium (Ti), molybdenum (Mo), manganese (Mn), and combinations thereof; I′ is selected from chromium (Cr), vanadium (V), iron (Fe), scandium (Sc), yttrium (Y), and combinations thereof; and J may be selected from vanadium (V), chromium (Cr), manganese (Mn), cobalt (Co), nickel (Ni), copper (Cu), and combinations thereof.

The above-listed compounds having a coating layer on their surfaces may also be used, or mixtures of the above-listed compounds and the compounds having a coating layer may be used. The coating layer may include a coating element compound such as an oxide, a hydroxide, an oxyhydroxide, an oxycarbonate, or a hydroxycarbonate of a coating element. The compounds constituting the coating layer may be amorphous or crystalline. The coating element included in the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. The coating layer may be formed by a suitable coating method that does not adversely affect the physical properties of the cathode active material using these coating elements in the above compounds (e.g., by spray coating, dipping, or the like).

For example, the cathode active material may be LiNiO₂, LiCoO₂, LiMnₓO₂ₓ where x=1 or 2, LiNi₁₋ₓMnₓO₂ where 0<x<1, LiNi_{1-x-y}CoₓMn_{y}O₂ where 0≤x≤0.5 and 0≤y≤0.5, LiFeO₂, V₂O₅, TiS, MoS, or the like.

In the cathode active material composition, the conductive material, the binder, and the solvent may be the same as those used in the anode active material composition. In an embodiment, pores may be formed in an electrode plate by further adding a plasticizer to the cathode active material composition and/or the anode active material composition.

The amounts of the cathode active material, the conductive material, the binder, and the solvent may be the same as those used in a general lithium battery. At least one of the conductive material, the binder, and the solvent may be omitted according to a use and constitution of lithium batteries.

A separator to be disposed between the cathode and the anode may be prepared. The separator may be a suitable separator for use in lithium batteries. The separator may have low resistance to migration of ions in an electrolyte and have an excellent electrolyte-retaining ability. Examples of the separator may include glass fiber, polyester, Teflon, polyethylene, polypropylene, polytetrafluoroethylene (PTFE), or combinations thereof, each of which may be a non-woven or woven fabric. For example, a rollable separator including polyethylene, polypropylene, or the like may be used for a lithium ion battery. A separator with a good organic electrolytic solution-retaining ability may be used for a lithium ion polymer battery. For example, the separator may be manufactured using the following method.

A polymer resin, a filler, and a solvent may be mixed together to prepare a separator composition. The separator composition may be directly coated onto an electrode, and then dried to form the separator. In some implementations, the separator composition may be cast onto a support and then dried to form a separator film, which may then be separated from the support and laminated onto an electrode, thereby completing the formation of a separator.

The polymer resin used to manufacture the separator may be a suitable material for use as a binder for electrode plates. For example, the polymer resin may be a vinylidenefluoride/hexafluoropropylene copolymer, polyvinylidene fluoride (PVDF), polyacrylonitrile, polymethylmethacrylate, a mixture thereof, or the like.

An electrolyte may be prepared. The electrolyte may be an organic electrolyte solution. In some embodiments, the electrolyte may be in a solid phase. For example, the electrolyte may be a suitable solid electrolyte. For example, the electrolyte may be boron oxide, lithium oxynitride, or the like. The solid electrolyte may be formed on the anode by sputtering or the like.

For example, an organic electrolytic solution may be prepared. The organic electrolytic solution may be prepared by dissolving a lithium salt in an organic solvent.

The organic solvent may be a suitable organic solvent for use in an organic electrolytic solution. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, a mixture thereof, or the like.

The lithium salt may be a suitable lithium salt for use in an organic electrolytic solution. For example, the lithium salt may include LiPF₆, LiBF₄, LiSbF₆, LiAsF₆, LiClO₄, LiCF₃SO₃, Li(CF3SO₂)₂N, LiC₄F₉SO₃, LiAlO₂, LiAlCl₄, LiN(CₓF₂ₓ₊₁SO₂)(C_{y}F_{2y+1}SO₂) where x and y are natural numbers, LiCl, LiI, or mixtures thereof.

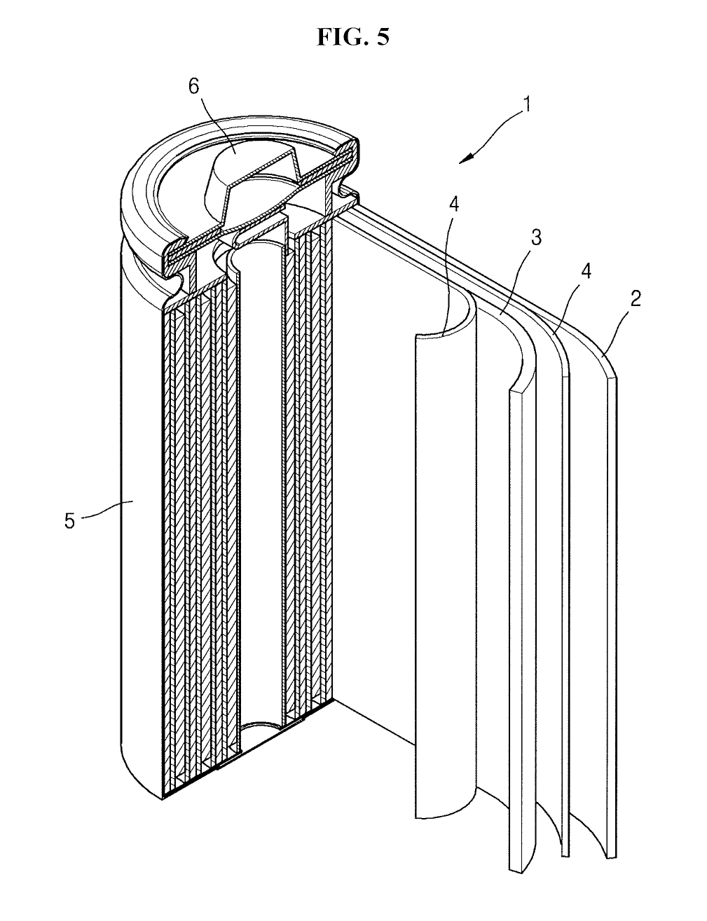

As illustrated in FIG. 5, a lithium battery 1 may include a cathode 3, an anode 2, and a separator 4. The cathode 3, the anode 2, and the separator 4 may be wound or folded, and then accommodated in a battery case 5. Subsequently, an organic electrolytic solution may be injected into the battery case 5, and the battery case 5 may be sealed with a cap assembly 6, thereby completing the manufacture of the lithium battery 1. The battery case may be a cylindrical type, a rectangular type, a thin-film type, or the like. For example, the lithium battery may be a thin-film type battery. The lithium battery may be a lithium ion battery.

The separator may be disposed between the cathode and the anode to form a battery assembly.

In some implementations a plurality of the battery assemblies may be stacked in a bi-cell structure and impregnated with an organic electrolytic solution. The obtained resulting structure may be accommodated in a pouch and sealed, thereby completing the manufacture of a lithium ion polymer battery.

In some implementations, the battery assemblies or a plurality of the lithium batteries may be stacked to form a battery pack. The battery pack may be used in a device that requires high capacity and high power output, for example, in a laptop computer, a smartphone, an electric vehicle, or the like.

The lithium battery as described herein may have excellent high-rate characteristics and excellent lifespan characteristics. Thus, the lithium battery may be suitable for use in electric vehicles (Evs). For example, the lithium battery may be suitable for use in hybrid vehicles such as plug-in hybrid electric vehicles (PHEVs), or the like.

In the present specification, a substituent may be derived by substitution of at least one hydrogen atom in an unsubstituted mother group with another atom or a functional group. Unless stated otherwise, the term “substituted” indicates that the above-listed functional groups are substituted with at least one substituent selected from a C₁-C₄₀ alkyl group, a C₂-C₄₀ alkenyl group, a C₂-C₄₀ alkynyl group, a C₃-C₄₀ cycloalkyl group, a C₃-C₄₀ cycloalkenyl group, and a C₇-C₄₀ aryl group. The phrase “optionally substituted” as used herein indicates that the functional groups described above may be substituted with the aforementioned substituents.

As used herein, a and b of the expression “Cₐ-C_{b}” indicate the range of carbon atoms of a particular functional group. For example, the functional group may include a to b carbon atoms. For example, the expression “C₁-C₄ alkyl group” indicates an alkyl group having 1 to 4 carbon atoms, i.e., CH₃—, CH₃CH₂—, CH₃CH₂CH₂—, (CH₃)₂CH—, CH₃CH₂CH₂CH₂—, CH₃CH₂CH(CH₃)—, or (CH₃)₃C—.

A particular radical may be referred to as a mono-radical or a di-radical depending on the context. For example, when a substituent uses two binding sites for binding with the rest of a molecule, the substituent may be understood as a di-radical. For example, a substituent specified as an alkyl group that needs two binding sites may be a di-radical, such as —CH₂—, —CH₂CH₂—, —CH₂CH(CH₃)CH₂—, or the like. The term “alkylene” as used herein clearly indicates that the radical is a di-radical.

The terms “alkyl group” and “alkylene group” as used herein refer to a branched or unbranched aliphatic hydrocarbon group. In an embodiment, the alkyl group may be substituted or unsubstituted. Non-limiting examples of the alkyl group include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, and a cycloheptyl group, each of which may be optionally substituted or unsubstituted. In an embodiment, the alkyl group may have 1 to 6 carbon atoms. For example, a C₁-C₆ alkyl group may be methyl, ethyl, propyl, isopropyl, butyl, iso-butyl, sec-butyl, pentyl, 3-pentyl, hexyl, or the like.

The term “alkenyl group” as used herein refers to a hydrocarbon group having 2 to 20 carbon atoms with at least one carbon-carbon double bond. Non-limiting examples of the alkenyl group include an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexenyl group, and a cycloheptenyl group. In an embodiment, these alkenyl groups may be substituted or unsubstituted. In an embodiment, the alkenyl group may have 2 to 40 carbon atoms.

The term “alkynyl group” as used herein refers to a hydrocarbon group having 2 to 20 carbon atoms with at least one carbon-carbon triple bond. Examples of the alkynyl group include an ethynyl group, a 1-propynyl group, a 1-butynyl group, and a 2-butynyl group. In an embodiment, these alkynyl groups may be substituted or unsubstituted. In an embodiment, the alkynyl group may have 2 to 40 carbon atoms.

The term “cycloalkyl group” as used herein refers to a fully saturated carbocyclic ring or ring system. For example, the cycloalkyl group may be a cyclopropyl group, a cyclobutyl group, a cyclopentyl group, or a cyclohexyl group.

The term “aromatic” as used herein refers to a ring or ring system with a conjugated π electron system, and may refer to a carbocyclic aromatic group (e.g., a phenyl group) or a heterocyclic aromatic group (e.g., pyridine). In this regard, an aromatic ring system as a whole may include a monocyclic ring or a fused polycyclic ring (i.e., a ring that shares adjacent atom pairs).

The term “aryl group” as used herein refers to an aromatic ring or ring system (i.e., a ring fused from at least two rings that shares two adjacent carbon atoms) having only carbon atoms in its backbone, or a ring in which a plurality of aromatic rings are linked to each other by a single bond, —O—, —S—, —C(═O)—, —S(═O)₂—, or —Si(Rₐ)(R_{b})— where each of Rₐ and R_{b} is independently a C₁-C₁₀ alkyl group, a halogen-substituted or unsubstituted C₁-C₁₀ alkylene group, or —C(═O)—NH—. When the aryl group is a ring system, each ring in the ring system is aromatic. Examples of the aryl group include a phenyl group, a biphenyl group, a naphthyl group, a phenanthrenyl group, and a naphthacenyl group. These aryl groups may be substituted or unsubstituted.

The term “arylene group” as used herein refers to an aryl group having at least two binding sites. A tetravalent arylene group is an aryl group having four binding sites, and a divalent arylene group is an aryl group having two binding sites. For example, an arylene group may be —C₆H₅—O—C₆H₅—, and or like.

The term “heteroaryl group” as used herein refers to an aromatic ring system with one ring, or a plurality of fused rings or a plurality of rings linked to each other by a single bond, —O—, —S—, —C(═O)—, —S(═O)₂—, or —Si(Rₐ)(R_{b})— where each of Rₐ and R_{b} is independently a C₁-C₁₀ alkyl group, a halogen-substituted or unsubstituted C₁-C₁₀ alkylene group, or —C(═O)—NH—, and in which at least one ring atom is not carbon, i.e., is a heteroatom. In the fused ring system, at least one heteroatom may be present in only one ring. The heteroatom may be, for example, oxygen, sulfur, or nitrogen. Non-limiting examples of the heteroaryl group include a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, and an indolyl group.

The term “heteroarylene group” as used herein refers to a heteroaryl group having at least two binding sties. A tetravalent heteroarylene group is a heteroaryl group having four binding sites, and a divalent heteroarylene group is a heteroaryl group having two binding sites.

The terms “aralkyl group” and “alkylaryl group” as used herein refer to an aryl group linked as a substituent via an alkylene group, such as a C₇-C₁₄ aralkyl group. Non-limiting examples of the aralkyl group or alkylaryl group include a benzyl group, a 2-phenylethyl group, a 3-phenylpropyl group, and a naphthylalkyl group. In an embodiment, the alkylene group may be a lower alkylene group (i.e., a C₁-C₄ alkylene group).

The term “cycloalkenyl group” as used herein refers to a non-aromatic carbocyclic ring or ring system with at least one double bond. For example, the cycloalkenyl group may be a cyclohexenyl group.

The term “heterocyclic group” as used herein refers to a non-aromatic ring or ring system having at least one heteroatom in its ring backbone.

The term “halogen” as used herein refers to a stable element belonging to Group 17 of the periodic table, for example, fluorine, chlorine, bromine, or iodine. For example, the halogen may be fluorine and/or chlorine.

Weight average molecular weights of the first, second, and third polymers are measured by gel permeation chromatography (GPC) using a polystyrene standard sample.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparation of Composite Anode Active Material

### Example 1

100 parts by weight of a silicon-carbon composite powder (average particle diameter: 10 μm to 15 μm, manufactured by BTR) and 2 parts by weight of a polyacrylic acid (weight average molecular weight: 15,000 Daltons, manufactured by Aldrich) were uniformly mixed in a tubular mixer at 100 rpm for 30 minutes, and then dried in an oven at 80° C., thereby completing the preparation of a composite anode active material including a silicon-carbon composite core coated with polyacrylic acid.

### Example 2

A composite anode active material was prepared in the same manner as in Example 1, except that a polyacrylic acid having a weight average molecular weight of 2,000 Daltons was used.

### Example 3

A composite anode active material was prepared in the same manner as in Example 1, except that a polyacrylic acid having a weight average molecular weight of 100,000 Daltons was used.

### Example 4

A composite anode active material was prepared in the same manner as in Example 1, except that a polyacrylic acid having a weight average molecular weight of 250,000 Daltons was used.

### Example 5

A composite anode active material was prepared in the same manner as in Example 1, except that the amount of the added polyacrylic acid was 0.2 parts by weight.

### Example 6

A composite anode active material was prepared in the same manner as in Example 1, except that the amount of the added polyacrylic acid was 5 parts by weight.

### Example 7

A composite anode active material was prepared in the same manner as in Example 1, except that the amount of the added polyacrylic acid was 7 parts by weight.

### Comparative Example 1

Silicon-carbon composite powder (average particle diameter: 10 μm to 15 μm, manufactured by BTR) was directly used as a composite anode active material.

### Comparative Example 2

A composite anode active material was prepared in the same manner as in Example 1, except that polyimide (PI) (Alfa Aesar, Mw=588.6) having a repeating unit represented by Formula 3 below was used instead of polyacrylic acid.

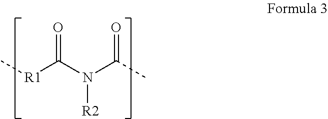

wherein, in Formula 3, R1 is a methylene group, and R₂ is oxygen.

### Comparative Example 3

A composite anode active material was prepared in the same manner as in Example 1, except that polyvinylchloride (PVC) (Aldrich, Mw=˜43,000) having a repeating unit represented by Formula 4 below was used instead of polyacrylic acid.

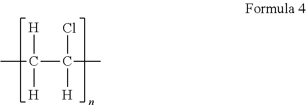

### Comparative Example 4

A composite anode active material was prepared in the same manner as in Example 1, except that polymethylmethacrylate (PMMA) (Aldrich, Mw=15,000) having a repeating unit represented by Formula 5 below was used instead of polyacrylic acid.

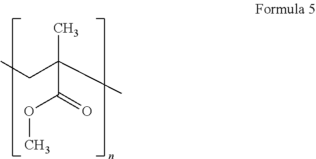

### Manufacture of Anode and Lithium Battery

### Example 8

### Manufacture of Anode

An anode active material slurry was prepared by mixing the powder-type composite anode active material prepared according to Example 1, graphite, styrene-butadiene rubber (SBR), and carboxymethylcellulose (CMC) having a repeating unit of Formula 6 below in a PD mixer (manufactured by KM Tech) in a weight ratio of 9:88:1.5:1.5. The anode active material slurry was coated onto a Cu foil having a thickness of 10 μm using a 3-roll coater to a thickness of 50 μm to 60 μm and dried at room temperature, followed by further drying in vacuum at 120° C., to manufacture an anode plate. The anode plate was pressed using a roll press to thereby complete the manufacture of an anode.

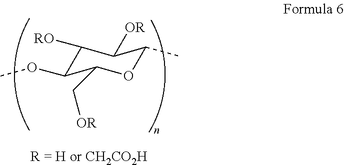

### Manufacture of Cathode

LiNi_{0.8}Co_{0.15}Al_{0.05}O₂ as cathode active material powder and Denka black as a carbon conductive material were uniformly mixed, and then a pyrrolidone solution including polyvinylidene fluoride (PVDF) as a binder was added to the resulting mixture to prepare a cathode active material slurry in which the cathode active material, the carbon conductive material, and the binder were mixed in a weight ratio of 97:1.4:1.6. The cathode active material slurry was coated onto an Al foil having a thickness of 15 μm using a 3-roll coater to a thickness of 70 μm, followed by further drying in vacuum at 110° C. to manufacture a cathode plate. The cathode plate was pressed using a roll press to thereby complete the manufacture of a cathode.

### Manufacture of Lithium Battery

A lithium battery (18650 battery) was manufactured using the cathode, the anode, a polyethylene separator having a thickness of 20 μm (Star® 20) as a separator, and a solution prepared by dissolving 1.3 M LiPF₆ as a lithium salt in a mixed solvent of ethylene carbonate (EC), diethyl carbonate (DEC), and ethyl methyl carbonate (EMC) in a volume ratio of 3:5:2 (EC:DEC:EMC) as an electrolyte. The lithium battery had a capacity of about 600 mAh/g.

### Examples 9 to 14

Lithium batteries were manufactured in the same manner as in Example 8, except that the powder-type composite anode active materials prepared according to Examples 2 to 7, respectively, were used instead of the composite anode active material of Example 1.

### Comparative Examples 5 to 8

Lithium batteries were manufactured in the same manner as in Example 8, except that the powder-type composite anode active materials prepared according to Comparative Examples 1 to 4, respectively, were used instead of the composite anode active material of Example 1.

### Comparative Example 9

A lithium battery was manufactured in the same manner as in Example 8, except that PI was used as a binder instead of SBR and CMC.

### Comparative Examples 10 to 13

Lithium batteries were manufactured in the same manner as in Comparative Example 9, except that the powder-type composite anode active materials prepared according to Comparative Examples 1 to 4, respectively, were used instead of the composite anode active material of Example 1.

### Evaluation Example 1: Infrared (IR) Spectrum Analysis

Each of a composition obtained by drying, at room temperature, each of polyacrylic acid used in Example 1, SBR/CMC used as a binder in Example 8, and the anode active material composition of Example 8; and the anode active material composition of Example 8 was dried at room temperature, followed by further drying in vacuum at 120° C., and IR spectrum of each resulting composition was measured to confirm the presence or absence of crosslinking.

In the composition obtained by drying, at room temperature, each of polyacrylic acid used in Example 1, SBR/CMC used as a binder in Example 8, and the anode active material composition of Example 8, a sharp peak appeared in the range of 3,700 cm⁻¹ to 2,700 cm⁻¹ corresponding to a hydroxyl group.

In contrast, in the resulting composition obtained by drying the anode active material composition of Example 8 at room temperature and then further drying the dried anode active material composition in vacuum at 120° C., ester bonding was formed via crosslinking between a carboxyl group of polyacrylic acid and a hydroxyl group of a CMC binder, and thus a peak appearing in the range of 3,700 cm⁻¹ to 2,700 cm⁻¹ corresponding to a hydroxyl group was comparatively decreased, from which it could be confirmed that crosslinking was formed.

### Evaluation Example 2: Measurement of Specific Surface Area

Specific surface areas of the silicon-carbon composite powder (average particle diameter: 10 μm to 15 μm, manufactured by BTR) of Example 1, the powder-type composite anode active material of Example 1, and the resulting powder obtained by curing the powder-type composite anode active material of Example 1 at 150° C. for 2 hours were measured using a nitrogen adsorption experiment, and the results thereof are shown in Table 1 below.

TABLE 1

| | Specific surface |
|---|---|
| | area [m²/g] |
| Silicon-carbon composite of Example 1 | 102 |
| Composite anode active material of Example 1 | 40 |
| Powder obtained by curing the composite | 12 |
| anode active material of Example 1 at 150° C. | |
| for 2 hours | |

As shown in Table 1, the silicon-carbon composite powder used as a core in Example 1 had a specific surface area of 102 m²/g, while exhibiting a decreased specific surface area, i.e., 40 m²/g, due to being coated with polyacrylic acid and a significantly decreased specific surface area, i.e., 12 m²/g, due to the heat treatment. Thus, a side reaction between the core and an electrolyte may be decreased due to the decreased specific surface area of the composite anode active material, and, accordingly, initial efficiency and charge/discharge characteristics of a lithium battery may be enhanced.

### Evaluation Example 3: Evaluation of Charge/Discharge Characteristics

Each of the lithium batteries manufactured according to Examples 8 to 14 and Comparative Examples 5 to 12 was charged at a constant current of 0.2 C rate at 25° C. until the voltage reached 4.20 V (vs. Li). Subsequently, each lithium battery was discharged at a constant current of 0.2 C until the voltage reached 2.8 V (vs. Li) (Formation operation).

After the formation operation, each lithium battery was charged at a constant current of 1.0 C rate at 25° C. until the voltage reached 4.2 V (vs. Li). Subsequently, each lithium battery was discharged at a constant current of 1.0 C until the voltage reached 2.8 V (vs. Li). This cycle of charging and discharging was repeated 100 times.

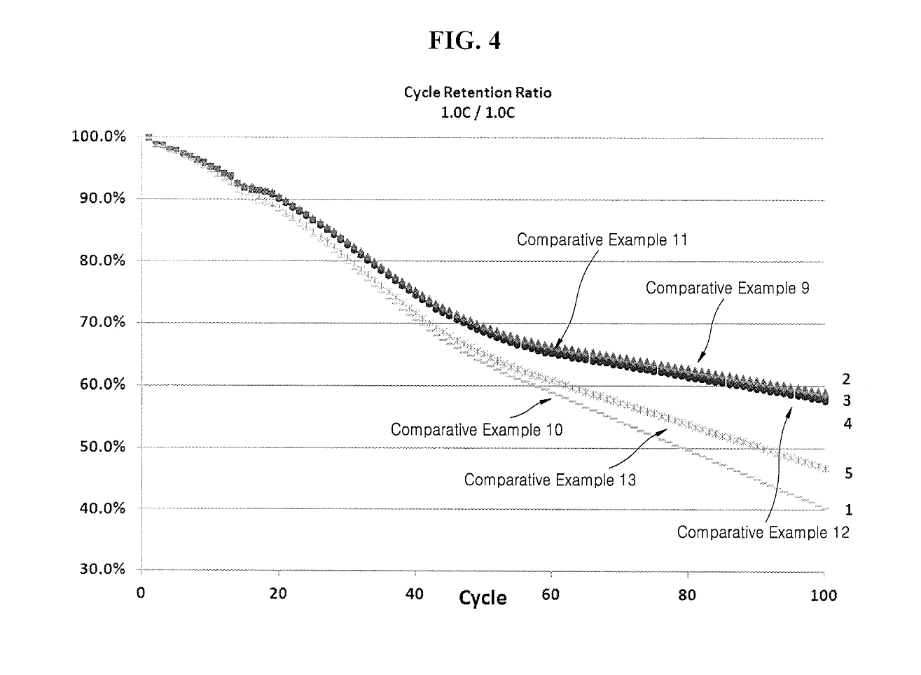

Some of the charging and discharging experiment results are shown in Table 2 below and FIG. 4. An initial charge/discharge efficiency is represented by Equation 1 below, and a capacity retention ratio is represented by Equation 2 below.

Initial charge/discharge efficiency [%]=[discharge capacity at 1^{st} cycle/charge capacity at 1^{st} cycle]×100 Equation 1

Capacity retention ratio [%]=[discharge capacity at 100^{th} cycle/discharge capacity at 1^{st} cycle]×100 Equation 2

TABLE 2

| | Capacity retention |
|---|---|
| | ratio [%] |
| Example 8 (PAA, Mw = 15,000) | 79.3 |
| Example 9 (PAA, Mw = 2,000) | 85.0 |
| Example 10 (PAA, Mw = 100,000) | 74.6 |
| Example 11 (PAA, Mw = 250,000) | 63.5 |
| Comparative Example 5 (PAA non- | 62.4 |
| coated) | |

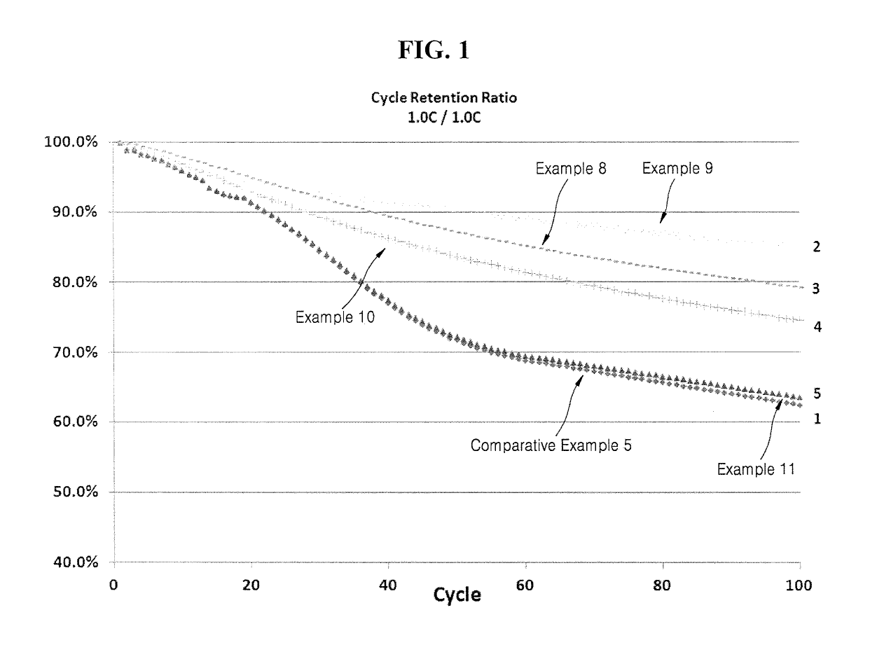

As shown in Table 2 and FIG. 1, the lithium batteries of Examples 8 to 11 including the anodes including a composite anode active material in which the core is coated with polyacrylic acid of various molecular weights exhibited superior lifespan characteristics to those of the lithium battery of Comparative Example 5.

In addition, the lithium batteries of Examples 8 to 10 exhibited significantly enhanced lifespan characteristics as compared to those of the lithium battery of Example 11.

TABLE 3

| | Capacity retention |
|---|---|
| | ratio [%] |
| Example 8 (PAA: 2 wt % coated) | 79.3 |
| Example 12 (PAA: 0.2 wt % coated) | 74.6 |
| Example 13 (PAA: 5 wt % coated) | 64.7 |
| Example 14 (PAA: 7 wt % coated) | 60.0 |
| Comparative Example 5 (PAA non- | 62.4 |
| coated) | |

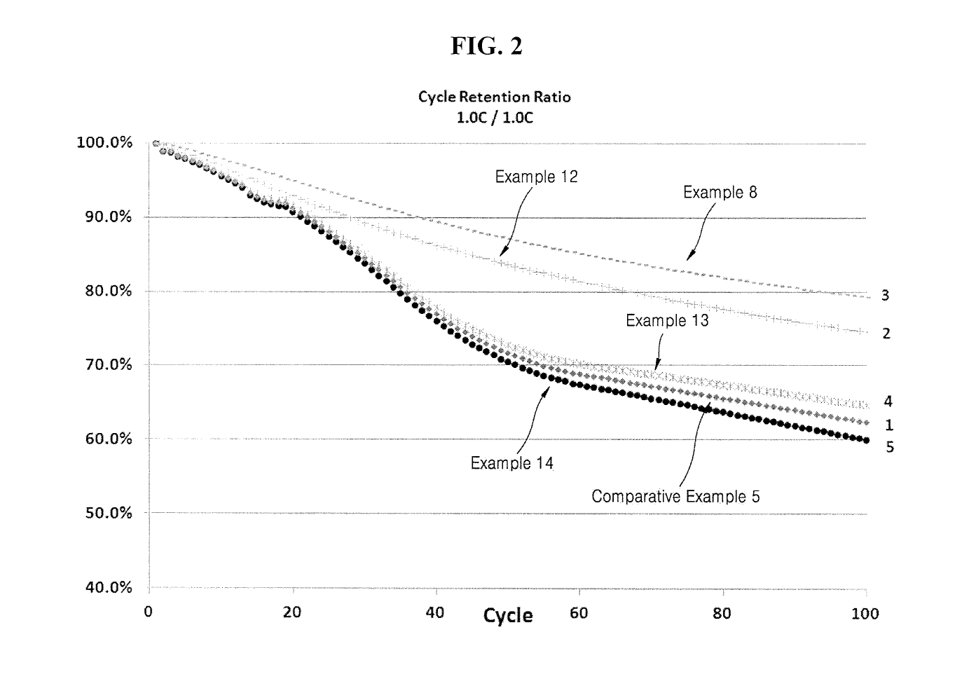

As shown in Table 3 and FIG. 2, the lithium batteries of Examples 8, 12, and 13 including the anodes including a composite anode active material in which the core is coated with various amounts of polyacrylic acid exhibited superior lifespan characteristics to those of the lithium battery of Comparative Example 5.

TABLE 4

| | Capacity retention |
|---|---|
| | ratio at 100th cycle |
| | [%] |
| Example 8 | 79.3 |
| (PAA coating + SBR/CMC binder) | |
| Comparative Example 5 | 62.4 |
| (No coating + SBR/CMC binder) | |
| Comparative Example 6 | 64.7 |
| (PI coating + SBR/CMC binder) | |
| Comparative Example 7 | 63.5 |
| (PVC coating + SBR/CMC binder) | |
| Comparative Example 8 | 68.1 |
| (PMMA coating + SBR/CMC binder) | |
| Comparative Example 9 | 59.2 |
| (PAA coating + PI binder) | |
| Comparative Example 10 | 40.4 |
| (No coating + PI binder) | |
| Comparative Example 11 | 58.6 |
| (PI coating + PI binder) | |
| Comparative Example 12 | 57.6 |
| (PVC coating + PI binder) | |
| Comparative Example 13 | 46.9 |
| (PMMA coating + PI binder) | |

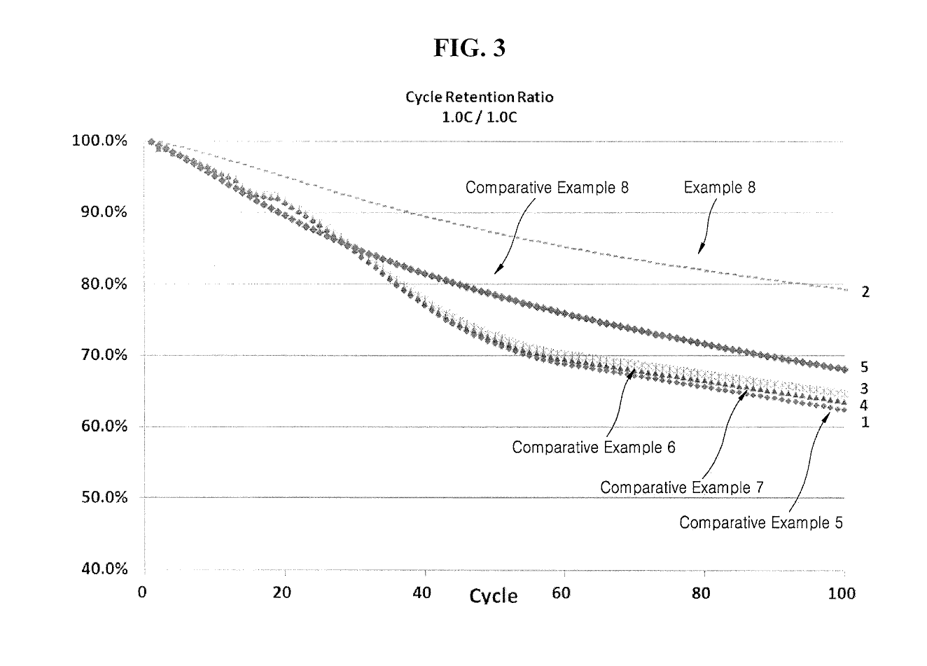

As shown in Table 4 and FIG. 3, the lithium battery of Example 8 including the anode including a composite anode active material in which the core is coated with polyacrylic acid exhibited significantly enhanced lifespan characteristics compared to those of the lithium batteries of Comparative Examples 5 and 6 to 8 including the uncoated anodes.

The enhanced lifespan characteristics of the lithium battery of Example 8 is believed to be due to crosslinking of polyacrylic acid, which is included in the coating layer of the composite anode active material, and the CMC binder via ester bonding between a carboxyl group of the polyacrylic acid and a hydroxyl group of the CMC binder. Thus the composite anode active material may have a strong adhesion via covalent bonding thereof with the binder, thereby suppressing volumetric changes during charging and discharging of the lithium battery.

In contrast, it the lithium batteries of Comparative Examples 6 to 8 it is difficult to form such cross-linking, and thus, it may be assumed that these lithium batteries have relatively poor lifespan characteristics.

In addition, as shown in Table 4 and FIG. 4, the lithium batteries of Comparative Examples 9 to 13 that are unable to form cross-linking using the hydroxyl group-free PI binder exhibited overall significant deterioration of lifespan characteristics compared to the lithium battery of Example 8.

### Evaluation Example 4: Measurement of Plate Expansion Rate

The lithium batteries assembled in Evaluation Example 1 were subjected to initial charging of formation operation, and then were disassembled and the thickness of each anode was measured, which was referred to as an anode thickness after charging.

The thickness of each anode before assembly of each lithium battery was measured and was referred to as an anode thickness before assembling.

A plate expansion rate is represented by Equation 3 below.

Thickness expansion rate (%)=[(anode thickness after charging−anode thickness before assembling)/anode thickness before assembling]×100 Equation 3

Plate expansion rates of the anode of the lithium battery of Example 8, the anode of the lithium battery of Comparative Example 5, and the anode of the lithium battery of Comparative Example 9 were measured, and the results thereof are shown in Table 5 below.

TABLE 5

| | Plate |
|---|---|
| | expansion |
| | rate [%] |
| Example 8 (PAA coating + SBR/CMC binder) | 26.8 |
| Comparative Example 5 (no coating + SBR/CMC binder) | 30.9 |
| Comparative Example 9 (PAA coating + PI binder) | 29 |

As shown in Table 5, the lithium battery of Example 8 exhibited a significantly decreased plate expansion rate compared to that of each of the lithium batteries of Comparative Examples 5 and 9.

Such decrease in the plate expansion rate is attributed to the fact that the composite anode active material and the binder were strongly adhered to each other via crosslinking between PAA and the CMC binder.

By way of summation and review, desirable characteristics for lithium batteries used in electrode vehicles include being operable at a high temperature, being able to be charged or discharged with a large amount of electricity, and being capable of be used for a long period of time.

Carbonaceous materials, which are porous, undergo small volumetric changes during charging and discharging, and thus are stable. However, carbonaceous materials generally exhibit low battery capacity due to having a porous carbon structure. For example, when graphite, which is a highly crystalline material, is formed as LiC6, it may have a theoretical capacity of only about 372 mAh/g. In addition, such graphite may have poor high-rate characteristics.

Anode active materials having higher electric capacities than those of such carbonaceous materials may include metals alloyable with lithium. Examples of the metals alloyable with lithium include silicon (Si), tin (Sn), and aluminum (Al). Such metals alloyable with lithium have high discharge capacities. However, these materials may easily deteriorate due to large volumetric changes thereof during charging and discharging, resulting in deteriorated lifespan characteristics.

Therefore, a lithium battery that has the higher electric capacity obtained through use of metals alloyable with lithium and that has enhanced lifespan characteristics by suppressing volumetric changes of the metals alloyable with lithium is desirable.

As is apparent from the foregoing description, according to an embodiment, a composite anode active material including a first polymer and a binder including a second polymer are cross-linked with each other, and thus a volumetric change of an anode is suppressed, and, accordingly, a lithium battery including the anode may have enhanced lifespan characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. An anode, comprising:
a composite anode active material including a core and a coating layer on the core, the core including a metal alloyable with lithium,
wherein:
the coating layer includes a first polymer having a first functional group and a binder including a second polymer having a second functional group, the first polymer and the second polymer being cross-linked with each other via ester bonding between the first functional group and the second functional group.

2. The anode as claimed in claim 1, wherein the first functional group and the second functional group each independently include at least one selected from a carboxyl group, a hydroxyl group, an amide group, and an aldehyde group.

3. The anode as claimed in claim 1, wherein the first functional group is a carboxyl group (—COOH), and the second functional group is a hydroxyl group (—OH).

4. The anode as claimed in claim 1, wherein the first polymer includes at least one selected from polyacrylic acid and polyamic acid.

5. The anode as claimed in claim 1, wherein the first polymer is a polyacrylic acid represented by Formula 1 below: 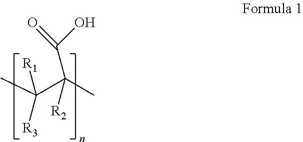
wherein, in Formula 1, R₁, R₂, and R₃ are each independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group; and
n is a degree of polymerization of about 10 to about 10,000.

6. The anode as claimed in claim 1, wherein the first polymer is a polyamic acid represented by Formula 2 below: 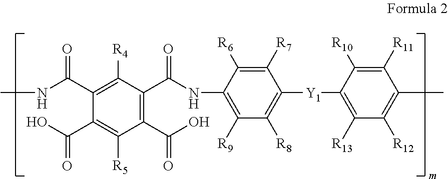
wherein, in Formula 2, R₄, R₅, R₆, R₇, R₈, R₉, R₁₀, R₁₁, R₁₂, and R₁₃ are each independently hydrogen, a halogen, a C₁-C₁₀ alkyl group substituted with a halogen, an unsubstituted C₁-C₁₀ alkyl group, a C₂-C₁₀ alkenyl group substituted with a halogen, an unsubstituted C₂-C₁₀ alkenyl group, a C₂-C₁₀ alkynyl group substituted with a halogen, an unsubstituted C₂-C₁₀ alkynyl group, a C₅-C₁₀ cycloalkyl group substituted with a halogen, an unsubstituted C₅-C₁₀ cycloalkyl group, a C₆-C₂₀ aryl group substituted with a halogen, an unsubstituted C₆-C₂₀ aryl group, a C₂-C₂₀ heteroaryl group substituted with a halogen, or an unsubstituted C₂-C₂₀ heteroaryl group;
Y₁ is a single bond, —O—, —S—, —C(═O)—, —S(═O)₂—, —Si(Rₐ)(R_{b})—, a C₁-C₁₀ alkylene group substituted with a halogen, an unsubstituted C₁-C₁₀ alkylene group, or —C(═O)—NH—, wherein Rₐ and R_{b} are each independently a C₁-C₁₀ alkyl group; and
m is a degree of polymerization of about 2 to about 10,000.

7. The anode as claimed in claim 1, wherein an amount of the first polymer ranges from about 0.01 wt % to about 5 wt % based on a total weight of the composite anode active material.

8. The anode as claimed in claim 1, wherein the first polymer has a weight average molecular weight of about 1,000 Daltons to about 250,000 Daltons.

9. The anode as claimed in claim 1, wherein a specific surface area of the composite anode active material is 80% or less of the specific surface area of the core.

10. The anode as claimed in claim 1, wherein the anode including the composite anode active material has a thickness expansion rate represented by Equation 3 below, the thickness expansion rate accounting for 95% or less of that of an anode including only the core:
Thickness expansion rate (%)=[(anode thickness after charging−anode thickness before assembling)/anode thickness before assembling]×100. Equation 3

11. The anode as claimed in claim 1, wherein the second polymer includes at least one selected from cellulose hydroxyethyl ether, dextran, carboxymethylcellulose (CMC), alginate, cellulose nanofiber, xanthan gum, and guar gum.

12. The anode as claimed in claim 1, wherein the core includes at least one metal selected from silicon (Si), tin (Sn), aluminium (Al), germanium (Ge), lead (Pb), zinc (Zn), silver (Ag), and gold (Au); an alloy, an oxide, a nitride, an oxynitride, or a carbide of the at least one metal; or a composite of the at least one metal and a carbonaceous material.

13. The anode as claimed in claim 1, wherein the core includes at least one selected from silicon, a silicon alloy, a silicon oxide, a silicon nitride, a silicon oxynitride, a silicon carbide, and a silicon-carbon composite.

14. The anode as claimed in claim 1, wherein the core includes: composite particles of silicon and carbon and a carbonaceous coating layer on a surface of the composite particles.

15. A lithium battery comprising the anode as claimed in claim 1.
